(19) United States
(12) Patent Application Publication
(10) Pub. No.: US 2003/0098411 A1
(43) Pub. Date: May 29, 2003

(54) Diffraction laser optical scale having high tolerance to the phase difference and alignment error of the grating opitcal scale

(76) Inventors: Chih-Kung Lee, Taipei (TW); Liang-Bin Yu, Taipei (TW); Chyan-Chyi Wu, Taipei (TW); Shu-Sheng Lee, Taipei (TW); Wen-Jong Wu, Taipei (TW); Ming-Hua Wen, Taipei (TW); Zheng-Sheng Pan, Taipei (TW); Shih-Jui Chen, Taipei (TW); Yen-Fu Lai, Taipei (TW); Giin-Yuan Wu, Taipei (TW)

Correspondence Address: J.C. Patents, Inc., Suite, 4 Venture, Irvine, CA, 92618, US

(21) Appl. No.: 09/997,351

(22) Filed: Nov. 27, 2001

(51) Int. Cl. H01J 3/14; H01J 5/16

(52) U.S. Cl. 250/237 G

(57) ABSTRACT

The invention is using the phase information contained in the diffraction light of the grating, to analyze the velocity and the displacement of the object having the grating attached. By using the relative placement of the optical elements, the entire optical scale system has high tolerance to the phase difference that is caused by the grating optical scale and the relative calibration error of the grating optical scale and the laser light head. Due to the light beam is focused on the diffraction grating, the wave-front of the signal light is relatively not impacted by the geometrical characteristics of the diffraction grating, the geometrical characteristics of the diffraction grating includes something like the interval is not even or the surface is bending. The excellent signal visibility can be obtained by applying the linear grating, radial grating, or the cylindrical grating as the grating in the design according to the present invention.

### BACKGCIRCULAR OF THE INVENTION

1. Field of Invention

The invention relates to optical scale. Particularly, the invention relates to laser optical scale.

2. Description of Related Art

There are two different types of optical scales commonly used now. Both of them have the same basic idea to modulate the light signal by moving the grating and to analyze the moving velocity and the position shift of the grating by receiving a modulated signal. The only difference between them is in the method of the light modulation and the analysis process of the light signal. The first type of optical scale is the geometrical optical scale (as shown in FIG. 1), and the second type of optical scale is the diffraction optical scale (as shown in FIG. 2). The geometrical optical scale shown as an example in FIG. 1 is based on the geometrical optics. The Light Emitted Diode (LED) is generally used as a light source. The grating is attached on the moving object that is to be measured so that it modulates the distribution of the light intensity according to the relative movement between the grating and the optical head grating and then transfers the signal of the light intensity that is obtained into the electronic signal for processing. In a geometrical optical scale system, the interval of the grating is generally selected as the order about 10 μm which is about 10 times the wavelength of the general visible laser light. It is because the basic resolution of the geometrical system is directly proportional to the interval of the grating itself and the interval of the grating cannot be continuously deduced, thus the diffraction phenomenon makes the noise ratio of the system too small. Therefore, the only way to obtain a smaller resolution is to use the advancement of the segmenting of the electronic signals, which is also the major hidden problem of the geometrical optical scale now.

The second type of diffraction optical scale is the diffraction optical scale which is based on the diffraction optics. As shown in FIG. 2, the laser diode provides the source light with the same tone. The diffraction grating on the measured object is moved to modulate the incident grating for generating the phase variation of the diffraction light. The diffraction light is subsequently received and interfered. One or more light detectors transfer the signal of the light intensity to an electronic signal output. In the diffraction optical scale, in order to generate suitable diffraction phenomenon and diffraction angle, the interval of the grating is generally maintained to the order about 1 μm which is about 10 times the advantage comparing to the geometrical optical scale system. The interval of the grating is directly proportional to the system resolution. Thus, the interval of the grating can be continuously reduced as long as the diffraction light required can be generated. Accordingly, an enhancement of the measured resolution of the diffraction optical scale can be achieved not only by using the advancement of the segmenting of the electric signals, but also by reducing the interval of the grating.

Here, the phase modulation of the generated diffraction light, which is caused by the movement of the grating, can simply be described by the mathematical equation as described below. The Z-axis is the light axis and the grating is fixed on the XY plane. It is consistent in the Y direction, thus, Y=0. Further defines Comb(x)=Σdelta(x−n). Also considering, when |x|≦0.5, Rect(x)=1, otherwise, Rect(x)=0.

Assuming the depth of the grating is far smaller than the interval of the grating, after the parallel lights incident, the distribution of the light field of the refection light near the grating surface is approximately the shape of the grating. Thus, it can be seen as Comb(x/a)*Rect(x/b), where a represents the interval of the grating, *represents the convolution. Considering the far field diffraction phenomenon, it is accordance to the Fraunhofer diffraction pattern; the mathematical Fourier Transform can be used to equate the light field, in other word,

Comb(x/a)*Rect(x/b)>_{FT}Comb(aFₓ)Sinc(bFₓ) (1)

Thus, Fₓ=n/a, and each order of the diffraction light can be written as

U(x,t)˜exp(j(2πFₓx-ωt)) (2)

If the grating is moving with an equal velocity of Vₒ, x can be replaced by x-Vₒt, and then each order of the diffraction light can be represented as

$$\begin{matrix}U ( x , t ) ∼ exp ( j ( 2 π {F}_{x} ( x - {V}_{o} t ) - ω t ) ) \\ = exp ( j ( 2 π {F}_{x} ( x - ω t ) + 2 π {F}_{x} {V}_{o} t ) )\end{matrix} \qquad ( 3 )$$

When Vₒt=a and n=1, 2πFₓVₒt=2π. Thus, we know the phase of the .+. 1 first order diffraction beam is increased by 2π. With the same reason, the status of each order of the diffraction light is obtained.

As the techniques of the optical scale growth rapidly, a lot of the related patents have been published. Such as U.S. Pat. Nos. 3,738,753, 3,726,595, Japanese Utility Model No. 81510/1982, Patent No. 207805/1982, 19202/1982, 98302/1985, U.K. Patent Application GB2185314A, U.S. Pat. Nos. 4,733,968/1988, 4,988,864/1991, 5,079,418/1992, 5,120,132/1992, 5,500,734/1996, 5,574,560/1996, Taiwan Application Serial No. 099283/1998, 099284, 096048, all can be seen as the prior art of the present invention.

FIG. 3 schematically shows an embodiment of the linear optical scale that is disclosed in the U. K. Patent No. GB3185314A by Canon. Here, the light with the same tone emitted by the laser 1 becomes parallel lights after passes through the parallel lens 2. The parallel lights subsequently split into two linear polarizing lights after being incident onto the polarizer 11. Wherein, the light beam that is reflected by the polarizer 11₁ becomes the circular polarizing light after passing through the quarter-wave plate 4₁, and is incident onto the diffraction grating 3. The specific order diffraction light that is generated by the diffraction grating 3 passes through a convergent lens 13₁, a light beam mask 15₁, and a reflector 14₁, and subsequently reflected to the original beam path. Thus, the diffraction light is incident onto the diffraction grating 3 again and generates the second diffraction light. The second diffraction light that is generated by the diffraction grating 3 then changes back to the linear polarizing light after passing through the quarter-wave plate 4₁. Then, the light continuously passes through the polarizer 11₁ and is incident onto the quarter-wave plate 4₂ and becomes a circular polarizing light. This circular polarizing light then is incident onto the reflector 16₁ and then reflected back to the quarter-wave plate 4₂. The polarizing state is subsequently changed back to the linear polarizing light after the light passes through the quarter-wave plate 4₂. Then the polarizer 11₁ reflects the light to the half-wave plate 12. The polarizing direction of the light beam that is reflected to the half-wave plate 12 rotates 90 degree due to the half-wave plate. Then the light beam passes through the polarizer 11₂ and is incident onto the quarter-wave plate 4₅ and becomes circular polarizing light. This circular polarizing light is subsequently split into two light beams after the circular polarizing light is incident onto the polarizer 17. Finally, these two light beams become linear polarizing lights after passing through the polarizing plate 7₁ and polarizing plate 7₂ respectively, and incident onto the light-receiving elements 8₁ and 8₂.

On the other hand, the transmission light that is generated by the polarizer 11₁ is incident onto the half-wave plate 12, and rotates 90 degree along the axis. The beam then is incident onto the polarizer 11₂ and is reflected to the quarter-wave plate 4₃ and becomes a circular polarizing light. The circular polarizing light then is incident onto the diffraction grating 3, and the specific order diffraction light that is generated by the diffraction grating 3 then passes through the convergent lens 13₂, the light beam mask 15₂, and the reflector 14₂. Thus, the diffraction light is incident onto the diffraction grating 3 again and generates the second diffraction light. Furthermore, the second diffraction light becomes a linear polarizing light after passing through the quarter-wave plate 4₃. The linear polarizing light directly passes through the polarizer 11₂ and is incident onto the quarter-wave plate 4₄. The circular polarizing light that is generated by the quarter-wave plate 4₄ is incident onto the reflector 16₂. After the reflector 16₂ reflects the circular polarizing light, the circular polarizing light changes back to the linear polarizing after passing through the quarter-wave plate 4₄. After that, the beam is incident onto the polarizer 11₂ and is reflected to the quarter-wave plate 4₅. After the beam is changed back to the circular polarizing light by passing through the quarter-wave plate 4₅, the beam is incident onto the polarizer 17 is polarized. Finally, these two light beams incident onto the corresponding light receiving elements 8₁ and 8₂, respectively. At this time, these two second diffraction lights coincide with the second diffraction lights that are generated by the original first light beam and generate the interfere stripe.

FIG. 4 is a system configuration diagram of the Canon linear optical scale L-104. As show in the diagram, the light beam that is emitted by the semiconductor laser becomes parallel lights after passing through the parallel lens. The parallel lights incident onto the polarizer and become two linear polarizing lights (i.e. P polarizing light and S polarizing light). After the diffraction lights incident onto the reflecting subsystem and reflected to the diffraction grating, these two light beams subsequently incident onto the diffraction grating from the two ends of the prism set and generate a +1 order diffraction light. The reflecting subsystem is a GRIN lens. In order to eliminate the image difference that is caused by the grating optical scale, the back of the GRIN lens are all-transparent except a small portion that is coated with a reflecting layer. In other word, this reflecting subsystem works like the operation of the filter optical difference by using pinhole. The second diffraction lights that are generated by the reflecting subsystem subsequently incident onto the prism set and coincide with each other. Finally, after the polarizing direction of the combined light beam is changed by the impact of the quarter-wave plate, the partial of the light beam incident onto the light receiving diode respectively and outputs the orthogonal signal.

FIG. 5 is an IBM laser optical scale that is used in the write mechanism of the disk server. As shown in the diagram, the laser light is paralleled fist, then incident onto the diffraction grating and generates the diffraction light. The +1 order diffraction light and the −1 order diffraction light respectively converge onto the reflector by the subsystem that comprises the lens and the reflector, and then reflect back to the diffraction grating. The distance between the position of the light spot that is back to the diffraction grating and the position of the light spot that is previously incident is 3 mm. Then these two light beams generate the second diffraction lights through the diffraction grating. Both of the light beams are perpendicularly to the plane of the diffraction grating and these two light beams coincide with each other and generate interfere stripe. The displacement of the diffraction grating makes the relative phase of these two diffraction lights modulated, and thus impacts the polarizing direction of the light beam that is generated after those two light beams coincide with each other. Thus, after the light receiving device receives the interfere stripe that is generated by the second diffraction lights, the orthogonal signal that represents the displacement of the diffraction grating can be obtained by using the conversion function of the photo electricity signal.

FIG. 6 is an embodiment disclosed in the Taiwan Application Serial No. 099283. As shown in the diagram, the linear polarizing direction of the light beam that is emitted by the laser diode 701 is pointing to 45 degree, thus makes the light intensity of the P polarizing light and S polarizing light distribute evenly. The linear polarizing light becomes parallel lights after passing through the parallel lens 702 and then polarized when incident onto the polarizer 703. Wherein the P polarizing light is incident onto the reflector lens 704 after passing through the polarizer 703 directly, and is reflected back to the quarter-wave plate 719. The S polarizing light is incident onto the reflector lens 705 after being reflected by the polarizer 703, and is reflected onto the quarter-wave plate 720. These two light beams that pass through the quarter-wave plates 719 and 720 respectively then jointly incident onto the light spot 718 of the reflecting diffraction grating 706. The incident angle of these two light beams and the interval of the diffraction grating are specially selected, to have the +1 order diffraction light that is the first portion of the incident light, and the −1 order diffraction light that is the second portion of the incident light are both perpendicularly to the plane of the grating. Those two first diffraction lights that are generated by the light spot 718, subsequently focus on the reflector 709 by passing through the lens 708. The relative distance between the diffraction grating 706, the lens 708, and the reflector 709 is selected particularly to make the light spot 718 of the diffraction grating 706 locate on the front focal point of the lens 708, and the reflector 709 locate on the back focal point of the lens 708. Thus, after the diffraction light mentioned above focuses onto the reflector 709 and then is reflected back to the lens 708, the light beam passes through the lens 708 and becomes parallel lights, and incident onto the light spot 718 of the diffraction grating 706 again and generate a second diffraction lights. After passing through the quarter-wave plate 719 and 720, respectively, these two second diffraction lights subsequently are incident onto the reflector 704 and 705, then the light beams are reflected respectively back to the polarizer 703 and coincide with each other. The quarter-wave plate 719 and 720 in the beam path rotate the polarizing direction of these two light beams 90 degree respectively. That is, the original incident P polarizing light becomes S polarizing light and is reflected by the polarizer 703 after passing through the optical system and return back to the polarizer 703. In addition, the first portion of the returned diffraction lights is diffracted twice in the +1 order, and the second portion of the diffraction lights is diffracted twice in the −1 order. Thus, when the diffraction grating is moving, the phase modulation of these two diffraction lights is positive and negative respectively.

After these two returned diffraction lights mentioned above are incident onto the polarizer 703 and coincide with each other, the combined light beam passes through the quarter-wave plate 710 to transfer these two light beams to the clock-wise circular polarizing light and the counter-clockwise circular polarizing light, wherein these two circular polarizing lights are perpendicularly to each other. The phases of these two diffraction lights are modulated by the diffraction grating 706. Thus, when these two circular polarizing lights that are orthogonal and have the same light intensity combine into a linear polarizing light, the direction of the linear polarizing light depends on the phase difference of these two returned diffraction lights. The linear polarizing light incident onto the non-polarizer 711 and the reflecting light that is generated by the non-polarizer 711 subsequently is incident onto the light detector 712. The measure of the light intensity from the light detector 712 can be used in the feedback control of the laser power. The transmission light passes through the non-polarizer 711 then is incident onto the non-polarizer 713 again. Finally, the reflecting light that is generated by the non-polarizer 713 is incident onto the light detector 716 after passing through the polarizing plate 714. The transmission light passes through the non-polarizer 713 incident onto the light detector 717 after passing through the polarizing plate 715. The polarizing direction of the polarizing plate 714 and 715 is located at a phase difference of 45 degree to make the outputs of the light detector 716 and 717, that represent the displacement signal of the grating, form two sets of the orthogonal sine wave signals having 90-degree difference each other.

In the embodiment mentioned above, the reflector 709 is located on the back focal point of the lens 708. Thus, the combination of the reflector 709 and the lens 708 forms an optical mechanism of the corner cubic reflector. Due to of the existence of this optical mechanism, after these two first diffraction lights are reflected, these two first diffraction lights securely proceed along the reverse direction of the original first diffraction light. That is, no matter the diffraction grating declines or rotates, the proceeding beam path of those two diffraction lights are not deviated as long as these two diffraction lights are kept within the valid aperture range of the lens 708 and the reflector 709. Furthermore, the lens 708 and the reflector 709 are both located on the same beam path of those two diffraction lights of the incident lights. The de-focus phenomenon caused by the mistake in manufacturing of the lens 708 and the reflector 709 makes both diffraction lights having the same phase difference. Therefore, the extra interfere strips that caused by the mistake of manufacture will not be generated when these two returned diffraction lights coincide with each other and generate the interfere stripe. Thus, the certain degree of error in the assembling process can be tolerated.

### SUMMARY OF THE INVENTION

According to the present invention, the major concept of the diffraction optical scale is the use of phase information contained in the diffraction light of the grating to analyze the velocity and the displacement of the object having the grating attached. Thus, the basic objective of the optical elements deployment of the optical scale is to project the light source onto the diffraction grating. It is because the optical elements had been reduced significantly and the diffraction grating itself is small compare to the general geometrical grating. Thus, the system is suitable for use in the positioning in the interior of the miniature system. Due to the light beam being focused on the diffraction grating, the wave-front of the signal light is relatively not impacted by the geometrical characteristics of the diffraction grating such as the interval being uneven or the surface being bending. Therefore, the fabulous signal visibility can be obtained by applying linear grating, radial grating, or cylindrical grating to the design of the grating.

When a variation on the interval of the grating surface occurs due to the geometrical factors such as the radial interval of the radiate grating increases along with the increase of the radius, or the difference of the interval along the direction of the tangent of the cylindrical grating. Both of these cause the wave front of the diffraction light to have different degree image difference. Generally speaking, the more violent the variation of the grating interval that is covered by the light spot is, the more deteriorated the image is. According to this, it is a better idea to diminish the number of period that is covered to the certain level, in which the diffraction phenomenon of the grating would still exist. This is one of the design concepts of the present invention. The diffraction grating line that is commonly used now is about 1.6 μm. The covered grating period variation is about 1200 times when the non-focused 2 mm laser light beam projects onto the grating. If the lens is selected appropriately and the light beam focuses and projects onto the grating, the light spot is about 30 μm. The covered grating period variation is about 20 times that is 1/60 compare to the previous one. Thus, the image difference of the wave front can be significantly reduced to enhance the visibility of the light signal and reduce the error in the signal analysis.

In order to have the incident light repeatedly projected onto the diffraction grating, and combine the returned two signal light beams, the beam path design according to the present invention dexterously utilizes the combination of the polarizer, the quarter-wave plate, and the reflector to enhance the utilization of the single optical element as much as possible, and significantly reduce the size of the light head, the cost of the elements and the difficulty of the assembly. Comparatively, the conventional optical scale is non-reducible in the size of the light head and complex in positioning, and expensive in cost, the present invention has more advantages to be widely applied in the industry detection and the miniature system.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 is a basic design diagram of the typical geometrical optical scale;

FIG. 2 is a system configuration diagram of the conventional linear optical scale using the reflecting diffraction grating;

FIG. 3 schematically shows a linear optical scale disclosed in the U.K. Patent Application GB2185314A;

FIG. 4 schematically shows a Japan Canon Corporation linear laser optical scale (L-104);

FIG. 5 schematically shows an IBM laser optical scale used in the writing mechanism of the disk server;

FIG. 6 is one of the embodiments of the optical scale disclosed in the Taiwan Application Serial No. 099283;

FIG. 7 schematically shows the first embodiment of the diffraction grating linear optical scale according to the present invention;

FIG. 8 schematically shows the second embodiment of the diffraction grating linear optical scale according to the present invention;

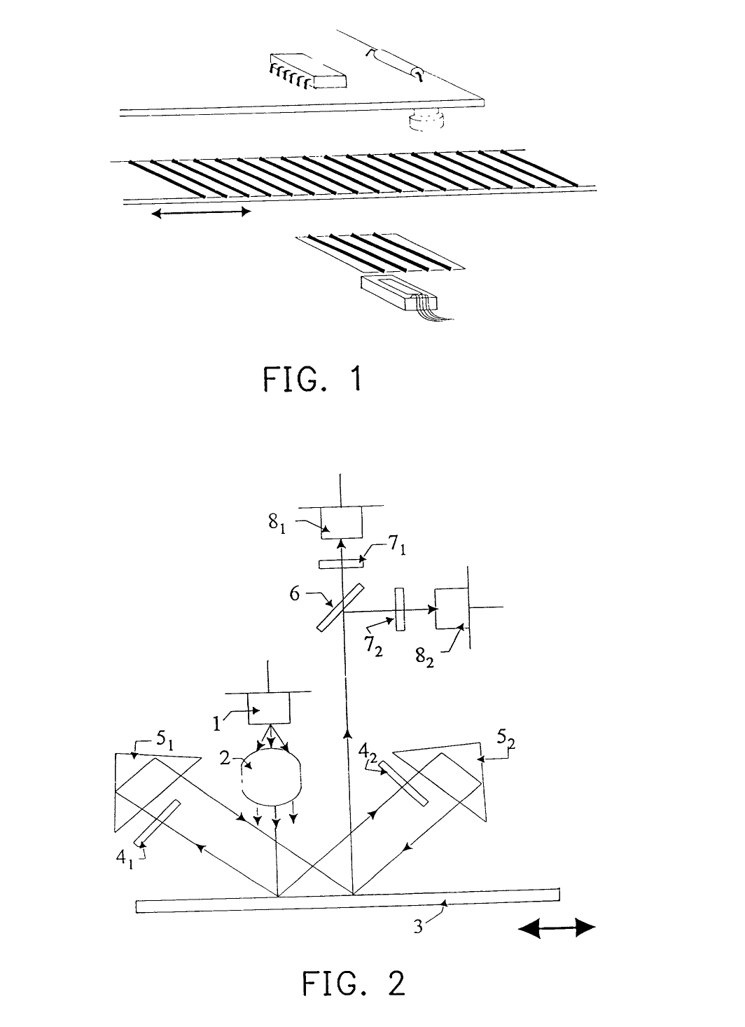

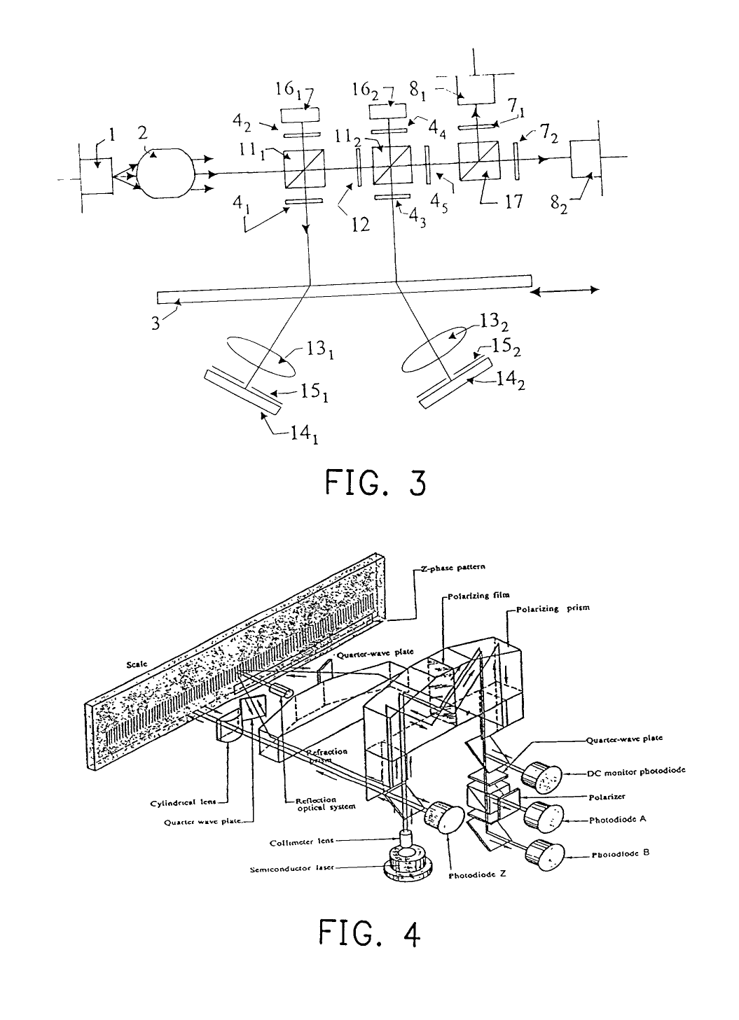

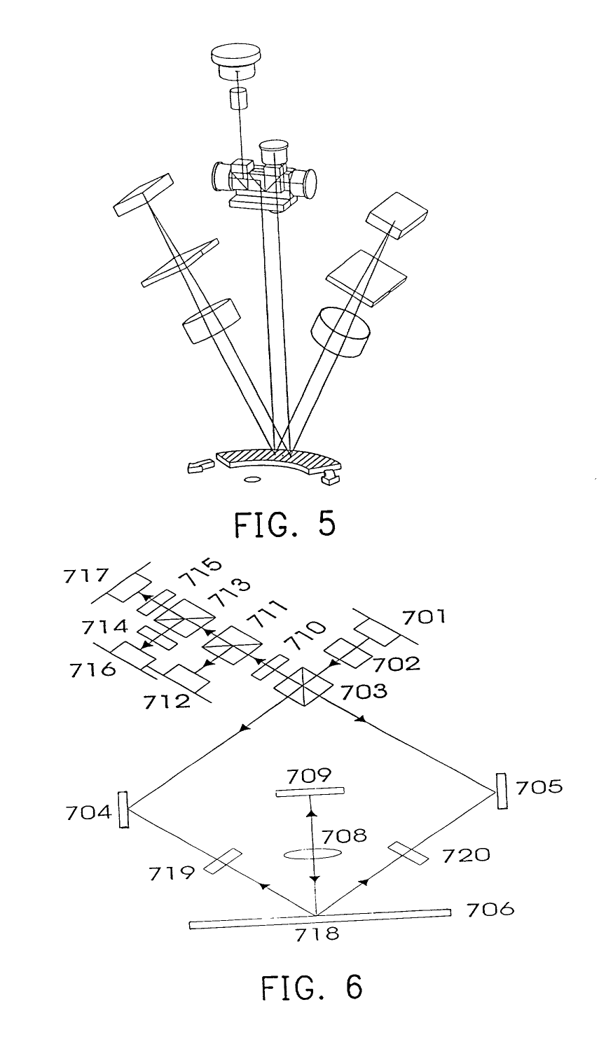

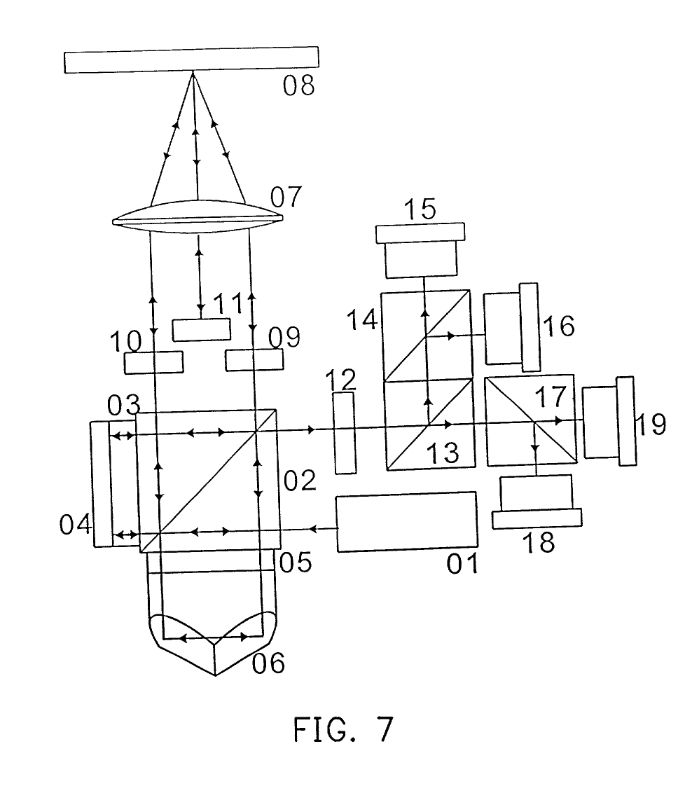

### DESCRIPTION OF THE PREFERRED EMBODIMENTS

FIG. 7 is a basic configuration diagram of the diffraction grating linear optical scale according to the present invention. In the invention, the light source 01 is a laser light source or a laser diode and the light emitted by the light source is polarized by the polarizer 02. The P polarizing light passes through the polarizer 02 and the quarter-wave plate 03, is incident onto the planar reflector 04 and is reflected by the planar reflector 04, then follows the original beam path back to the polarizer 02 and is reflected by the polarizer 02. The S polarizing light is reflected by the polarizer 02, and then passes through the quarter-wave plate 05, and is reflected by the corner cube reflector 06. The corner cube reflector 06 makes S polarizing light having a position shift in the parallel direction with the original incident path. The light beam then passes through the quarter-wave plate 05, is incident onto the polarizer 02 and passes through the polarizer 02 directly. The quarter-wave plate and the reflector mentioned above form a mechanism to rotate the polarizing direction of light π/2, thus to control the light beam passes through or reflects after entering into the polarizer. The corner cube reflector must be coated with a film to protect the polarizing state in order to have the beam path mentioned above to work as expected. These two parallel lights that are emitted by the polarizer 02 pass through the quarter-wave plate 09 and 10, respectively, are later focused by the convex lens 07, then incident onto the diffraction grating 08, diffract and generate the first .+−. 1 order diffraction light. Wherein the parameters of the convex lens must be selected to have the direction of the first .+−. 1 order diffraction light extremely parallel to the direction of the normal line of the grating plane. The first .+−. 1 order diffraction light subsequently passes through the convex lens 07 and the reflector 11, and returns to the diffraction grating and generates the second .+−. 1 order diffraction light. Wherein the reflector 11 must be located behind the focal point of the convex lens 07 to form an optical mechanism of the corner cube reflector. The second .+−. 1 order diffraction light is combined after following the original beam path back to the polarizer 02. These two linear polarizing lights then are transferred to the clock-wise circular polarizing light and the counter-clockwise circular polarizing light by the quarter-wave plate 12 in the back side, respectively. The non-polarizer 13 then splits these two circular polarizing lights into two light beams having the same light intensity. The polarizers 14 and 17 polarize each light beam. Wherein the polarizer 17 has a 45-degree decline in relates to the polarizer 14. Thus, the signal outputs from these two polarizers have a 90-degree phase difference. This is the basic source of the PQ orthogonal signals. The light detectors 15, 16 and 18, 18 that belong to each polarizer receive and transfer the light intensity into the voltage signals. The circuit portion subsequently subtracts the constant portion from the voltage signal that is derived from the light detectors 15 and 16 to obtain a pure Q orthogonal signal. The circuit portion also subtracts the constant portion from the voltage signal that is derived from the light detectors 18 and 19, to obtain a pure S orthogonal signal. The further comparison and the electronic fine division obtain the displacement vector and the velocity vector of the object that has grating attached on it.

The optical behavior of the combination of the convex 07 and the reflector 11 equals to a corner cube reflector. The wave-front and the position of the incident and reflected lights are symmetrical to the mirror center of the corner cube reflector to provide an evenness for the image difference that is caused by the relative decline of the grating plane and the light head plane.

In the optical mechanism mentioned above, the diffraction grating 08 can be linear, radial or cylindrical. Thus, the usage is wide-ranging. The bad signal caused by the image difference of the wave front can be significantly avoided by having the light beam been focused. Furthermore, the design of the beam path repeatedly utilizes the same elements, thus the size of the light head is smaller than all the other optical scales of the world, and the calibration process is easier that others also.

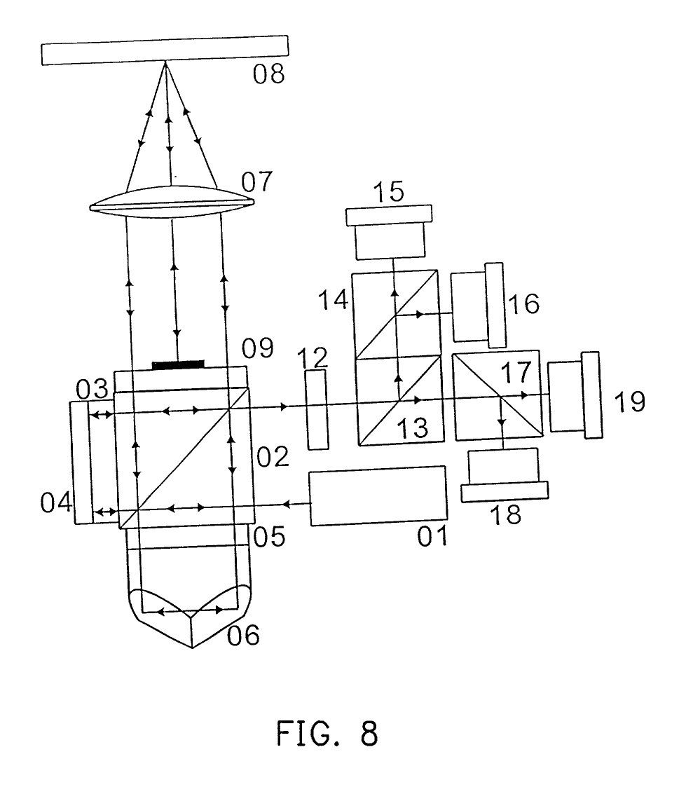

FIG. 8 is another configuration diagram of the diffraction grating linear optical scale according to the present invention. The differences from the previous configuration are that the quarter-wave plates 09 and 10 of the previous configuration are combined to a single quarter-wave plate. The reflector 11 is replaced by the directly coated film on the center of the quarter-wave plate 09. Also and, the coated film is still located behind the focal point of the convex lens 07 to form the optical mechanism of the corner cube reflector. This configuration further reduces the complexity of the optical elements and also simplifies the process of the optical calibration. Furthermore, the background noise that is caused by the reflected two light beams and the second diffraction lights entering into the light detector in the backside can be avoided. Those two reflected light beams are directly reflected by the diffraction grating. Thus, the ratio of signal to noise is enhanced significantly.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. An optical automatic control encoder, with a diffraction grating, which is immune from an unevenness of a grating surface interval, and has a high tolerance to a alignment error, at least comprising:
a light source, which generates a light beam having a sufficient coherence length;
an optical scale, having the diffraction grating, used to detect a displacement of an object that is under measured;
an optical head, which polarizes a single input signal light beam for providing outputs of two parallel light beams each having one linear polarizing state perpendicular to each other, and combines the two parallel light beams into a single output signal light beam, wherein since the a polarizing switch mechanism exists in a beam path, the single input signal light beam and the single output signal light beam can be shifted in position to apply both an input mechanism and an output mechanism simultaneously,
wherein the optical head splits the single input signal light beam into a first incident light and a second incident light, wherein both the first incident light and the second incident light are linearly polarized and perpendicular to each other,
wherein a polarizing direction of the first incident light is switched to be perpendicular to the original polarizing direction by passing through a first polarizing state switching mechanism, and a polarizing direction of the second incident light is also switched to be perpendicular to the original polarizing direction by passing through a second polarizing state switching mechanism, and the first incident light and the second incident light are transferred from the linear polarizing state to a circular polarizing state, and subsequently focus on the diffraction grating of the optical scale respectively;
wherein an angle between the direction of the first incident light and a normal direction of a plane of the diffraction grating must be sufficiently approximate to a first +1 order diffraction angle of the grating; a first +1 order diffraction light is generated after incidence, the first +1 order diffraction light is approximately perpendicular to the diffraction grating plane; an angle between the direction of the second incident light and the normal line direction of the diffraction grating plane must be approximately enough to the first −1 order diffraction angle of the grating;
wherein the first −1 order diffraction light is generated after being incident, the first −1 order diffraction light is approximately perpendicular to a diffraction grating plane; the first +1 order diffraction light is reversely incident onto the diffraction grating after reflection and a second +1 order diffraction light is generated; the second +1 order diffraction light coincides with the first incident light in space but a traveling direction is reverse; the first −1 order diffraction light is perpendicularly incident onto the linear diffraction grating and a second −1 order diffraction light is generated, the second −1 order diffraction light coincides with the second incident light in space but a traveling direction is reverse; after the polarizing state of the second +1 order diffraction light and the second −1 order diffraction light had been changed from the circular polarizing state back to the linear polarizing state again, the second +1 order diffraction light travels along the reverse direction of the first incident light, and a first output light beam is output by position shifting; the second −1 order diffraction light travels along a reverse direction of the second incident light and a second output light beam is output by position shifting; and the polarizing direction of the first output light beam is perpendicular to the polarizing direction of the second output light beam, these two output light beams can not be distinguished in space and form a signal light beam; and
a light signal analyzing system, which is used to split the signal light beam and detects a variation of light intensity; split the signal light beam equally into a first signal light beam and a second signal light beam; further split the first signal light beam into a first orthogonal light beam and a second orthogonal light beam, detect the first orthogonal light beam and the second orthogonal light beam and generate a first orthogonal signal and a second orthogonal signal with a phase difference between the first orthogonal signal and the second orthogonal signal, whereby a first orthogonal signal can be obtained by differentiating the first orthogonal signal and the second orthogonal signal; split the second signal light beam into a third orthogonal light beam and a fourth orthogonal light beam and detects the third orthogonal light beam and the fourth orthogonal light beam to generate a third orthogonal signal and a fourth orthogonal signal with a phase difference between the third orthogonal signal and the fourth orthogonal, whereby a second orthogonal signal can be obtained by differentiating the third orthogonal signal and the fourth orthogonal signal, wherein the first orthogonal signal and the second orthogonal signal have a phase difference of 90 degrees.

2. The optical automatic control encoder according to claim 1, wherein the diffraction grating in the optical scale is a linear diffraction grating.

3. The optical automatic control encoder according to claim 1, wherein the diffraction grating in the optical scale is a cylindrical diffraction grating.

4. The optical automatic control encoder according to claim 1, wherein the diffraction grating in the optical scale is a radiate diffraction grating.

5. The optical automatic control encoder according to claim 1, wherein the optical head comprises at least:
a polarizer, which provides the polarizing mechanism and a reflecting mechanism and a transmission mechanism due to the polarizing direction;
a right-angle reflector, which provides a reflecting mechanism and a position shifting mechanism;
a quarter-wave plate, which forms the first polarizing state switch mechanism by associating with the right-angle reflector;
a first planar reflector, which provides the reflecting mechanism;
a second quarter-wave plate, which forms the second polarizing state switch mechanism by associating with the first planar reflector;
a convex lens, which leads the two parallel lights that are output from the polarizer to the application system, and receives the diffraction light signal that is generated by the diffraction grating;
a third quarter-wave plate, which is located between the polarizer and the convex lens, to rotate the light polarizing state of the first incident light;
a fourth quarter-wave plate, which is located between the polarizer and the convex lens, to rotate the light polarizing state of the second incident light; and
a second planar reflector, which provides the reflecting mechanism for the first +1 order diffraction light and the first −1 order diffraction light, and associates with the third quarter-wave plate and the fourth quarter-wave plate to form a third polarizing state switch mechanism and a fourth polarizing state switch mechanism.

6. The optical automatic control encoder according to claim 1, wherein the light signal analyzing system comprises:
a quarter-wave plate, which transfers the single input signal light beam from a linear polarizing state to the circular polarizing state;
a first non-polarizer, which extracts a portion of the single input light beam to form a reference light beam;
a light detector, which receives the reference light beam and provides the signal that is needed for a source light power modulation;
a second non-polarizer, which evenly splits the residual signal light beam that passed through the light rotation-polarizing element, into a first signal light beam and a second signal light beam;
a first polarizer, which evenly splits the first signal light beam into a first orthogonal light beam and a second orthogonal light beam; and
a second polarizer, which evenly splits the second signal light beam into a third orthogonal light beam and a fourth orthogonal light beam.

7. The optical automatic control encoder according to claim 5, wherein the right-angle reflector includes a corner cube reflector having the silver coated film.

8. The optical automatic control encoder according to claim 5, wherein each of the first quarter-wave plate and the second quarter-wave plate includes a direct coating film on an exterior of the right-angle reflector.

9. The optical automatic control encoder according to claim 5, wherein the third quarter-wave plate and the fourth quarter-wave plate are a same quarter-wave plate, and the second planar reflector can be put on a center of the quarter-wave plate to simplify the configuration of those two quarter-wave plates and the planar reflector.
